(19) United States
(12) Patent Application Publication
(10) Pub. No.: US 2005/0266247 A1
(43) Pub. Date: Dec. 1, 2005

(54) Curved glass plate

(76) Inventor: Hideo Yoshizawa, Sagamihara-shi (JP)

Correspondence Address: FULBRIGHT & JAWORSKI, LLP, 666 FIFTH AVE, NEW YORK, NY, 10103-3198, US

(21) Appl. No.: 11/143,796

(22) Filed: Jun. 1, 2005

(30) Foreign Application Priority Data
Jun. 1, 2004 (JP) PAT. 2004-163157

(51) Int. Cl. B32B 17/00

(52) U.S. Cl. 428/410; 65/115

(57) ABSTRACT

A carved glass plate ha a curved peripheral spice portion where R1×R2 is 1,500,000 m² or less, R1 being a radius of curvature determined in a direction parallel to an edge of the glass plate, R2 being a radius of curvature determined in a direction normal to the direction. The curved peripheral surface portion includes a residual plane compressive stress zone and a residual plane tensile stress zone on the inner side of the residual plane compressive stress zone, the residual plane tensile stress zone having a tensile stress value below 8 MPa The glass plate has also a central portion located on the inner side of the residual plane tensile stress zone. This entire central zone is a residual surface compressive stress zone having a residual surface compressive stress value ranging from 10 MPa to 30 MPa.

### BACKGROUND OF THE INVENTION

1. Field of the Invention

The present invention relates to a curved glass plate including a curved peripheral surface portion where R1×R2 is 1,500,000 mm² or less, R1 being a radius of curvature determined in a direction parallel to an edge of the glass plate, R2 being a radius, of curvature determined in a direction normal to said direction.

2. Background Art

Such curved glass plate is for use as e.g. an outer glass plate of a laminated glass employed in a front or rear windshield or a side window of an automobile. In particular, such curved glass plate has a significantly or conspicuously bulging portion with a large curvature. In recent years, such glass plate having a large curvature has often been employed in e.g. front windshield of the automobile.

Such curved glass plate as described above is known from e.g. Japanese Patent Application National Publication No. 8-501272 and Japanese Patent Application “Kokai” No. 52-78226. The curved glass plates known from these documents are formed respectively by bending a glass plate with the effect of its own weight and then being slowly cooled. Unlike a tempered glass, however, such curved glass plate suffers the shortcoming of being weak against application of an external force thereto. For this reason, there has been a need for an improved curved glass plate highly resistant against application of an external force thereto.

In an attempt to satisfy such need, a reinforced curved glass plate is known. To obtain this, an upper mold is pressed against an upper face of a glass plate which is being supported along its periphery to a lower mold (commonly known in the art as a “ring mold”) thereby to bend the glass plate. Then, this bent glass plate is allowed to be cooled on the lower mold by natural radiational cooling, whereby the glass plate is reinforced or tempered. The present invention provides an improvement on such reinforced curved glass plate.

Next, the conventional method employed for obtaining such reinforced curved glass plate will be described in greater details.

In the following discussion, for the purpose of convenience of explanation, R1 will be used to denote a radius of curvature determined in a direction parallel to an edge of the glass plate and R2 will be used to denote a radius of curvature determined in a direction normal to said direction, respectively. Further, a mark A is used to denote a product value of a multiplication: R1×R2, a mark B is used to denote a tensile stress value of a residual plane tensile stress zone located on the inner side of a residual plane compressive stress zone in the peripheral edge of the curved glass plate, and a mark C is used to denote a residual surface compressive stress value of an entire central zone located on the inner side of the residual plane tensile stress zone, respectively.

Japanese Patent Application National Publication No. 2000-512612 (Patent Document 1) discloses a technique relating to the bending of a curved glass plate, but is silent about the above-defined elements A, B and C.

Like Patent Document 1 described above, Japanese Patent Application “Kokai” No. 5-1704568 (Patent Document 2) discloses a technique and an apparatus relating to the bending of a curved glass plate, but is silent about the above-defined elements A, B and C.

Japanese Patent Application “Kokai” No. 2002-234766 (Patent Document 3) is silent about the element A and describes only the element (value) B as being 8 MPa or greater and the element (value) C as ranging from 15 to 35 MPa.

Japanese Patent Application National Publication No. 6-503063 (Patent Document 4) is silent about the element A and describes only the element B as being 10 MPa or less and the element C as ranging from 40 to 100 MPa.

Japanese Patent Application “Kokai” No. 52-78226 (Patent Document 5) is silent about the element A and describes the element B as being 8 MPa or less, but is silent again about the element C.

Japanese Patent Application National Publication No. 8-506564 (Patent Document 6) is silent about the element A and describes the element B as being 6 MPa or less, but is silent again about the element C.

Japanese Patent Application “Kokai” No. 6-87328 Patent Document 7) is silent about the elements A and B and describes only the element C as being 35 MPa or more.

Japanese Patent Application “Kokai” No. 8-01272 describes the element A as being 67000 mm² or less, but is silent about the elements B and C.

Regarding the stress values B and C, in the case of the tensile stress value B of the residual plane tensile stress zone being too large, if a damage occurs in this zone due to e.g. hitting with a cast stone or the like, this damaged portion will be constantly exposed to a strong tensile stress thereafter. Hence, with lapse of time, spontaneous development of a crack will occur, thus eventually inviting break of the curved glass plate.

Also, if the residual surface compressive stress value C of the entire central zone is too small, this will result in danger of weakness of the glass plate against application of an external force thereto. Conversely, if the value C is too large, this will result in greater strength. However, in the event of a collision accident, the driver or the passenger can be exposed to a significant danger if his/her head hits the front windshield. Moreover, once a crack has been formed in the curved glass plate, this crack will likely be developed into too small fissures of the plate, which will suddenly hinder the drivers view, hence again presenting danger.

None of the above-cited Patent Documents 1-8 have successfully coped with these problems.

The present invention has been made to overcome the above-described shortcomings of the conventional art. A pi object of the invention is to further improve the curved glass plate having a portion of a large curvature, the improved curved glass plate of the invention being free of spontaneous development of crack due to damage to its surface. Further, even if a crack is formed in this glass plate, the crack will hardly hinder the driver's view, so that this curved glass plate can be particularly suitable for use as an outdoor side glass plate of a laminated glass employed in an automobile.

### SUMMARY OF THE INVENTION

In order to achieve the above-noted object, according to a first characterizing feature of the present invention, there is provided a carved glass plate including a curved peripheral surface portion where R1×R2 is 1,500,000 mm² or less, R1 being a radius of curvature determined in a direction parallel to an edge of the glass plate, R2 being a radius of curvature determined in a direction normal to said direction;

wherein said curved peripheral surface portion includes a residual plane compressive stress zone and a residual plane tensile stress zone on the inner side of the residual plane compressive stress zone, the residual plane tensile stress zone having a tensile stress value below 8 MPa; and

the glass plate further includes a central portion located on the inner side of the residual plane tensile stress zone, said entire central zone comprising a residual surface compressive stress zone having a residual surface compressive stress value ranging from 10 MPa to 30 MPa.

With the above-described first characterizing feature of the present invention, the curved glass plate includes a curved peripheral surface portion where R1×R2 is 1,500,000 mm² or less, R1 being a radius of curvature determined in a direction parallel to an edge of the glass plate, R2 being a radius of curvature determined in a direction normal to said direction. Such curved glass plate has a large curvature sufficient to be used in a curved laminated glass of e.g. a windshield of an automobile, which has been highly demanded in recent years.

Further, the residual plane tensile stress zone on the inner side of the residual plane compressive stress zone has a tensile stress value below 8 MPa and the entire central zone located on the inner side of the residual plane tensile stress zone comprises a residual spice compressive stress zone having a residual surface compressive stress value ranging from 10 MPa to 30 MPa. With these, even if the residual plane tensile stress zone is damaged by a cast stone or the like, there is no risk of spontaneous development of crack due to such damage. Moreover, even with sufficient strength assured, even if e.g. the driver head hits the glass plate in the event of a collision accident, the risk of his/her head being damaged is small, so that safety can be maintained. In addition, even when a crack is developed in the glass plate, this crack will hardly be formed into too small fissures in the plate which will suddenly hinder the driver's view. Therefore, it has become possible to provide a curved glass plate particularly suitable for use as an outdoor side glass plate of a laminated glass employed in an automobile.

According to a second characterizing feature of the present invention, said curved glass plate is for use as an outer glass plate of a laminated glass, said curved glass plate has a thickness of 1.5 to 2.5 mm, and said residual plane tensile stress zone is provided on an outer side of the curved surface of the curved glass plate, said residual plane tensile stress zone being covered with a compressive stress layer with a thickness of 0.16 mm or more in cross section thereof.

With the second characterizing feature of the present invention, since the curved glass plate has a thickness of 1.5 to 2.5 mm which thickness is optimum for use in a curved laminated glass for an automobile. Also, the residual plane tensile stress zone provided on an outer side of the curved surface of the curved glass plate is covered with a compressive stress layer with a thickness of 0.15 mm or more in cross section thereof. As a result, when this curved glass plate is employed as an outer glass plate of a laminated glass, even when the outer surface is damaged by a stone or the like, the above features effectively restrict such damage from reaching the tensile stress layer located on the thickness-wise inner side of the residual plane tensile stress zone. Consequently, the damage due to a stone or the like can be avoided more reliably.

According to a third character feature of the invention, said residual plane compressive stress zone has a residual surface compressive stress value ranging from 10 MPa to 70 MPa.

With the third characterizing feature of the invention, the residual surface compressive stress value of the residual plane compressive stress zone is set to range 10 MPa to 70 MPa Since the residual surface compressive stress value of the residual plane compressive stress zone is greater than 10 MPa, it is possible to assure sufficient for the curved glass plate. Further, since the residual surface compressive stress value of the residual plane compressive stress zone is less than 70 MPa, it is possible to prevent the tensile stress value of the residual plane compressive stress zone located on the inner side of the residual plane compressive stress zone from becoming too large. As a result, the damage due to a stone or the like can be avoided even more reliably.

Further and other features and advantages of the invention will become apparent upon reading the following detailed disclosure of preferred embodiments thereof with reference to the accompanying drawings.

### BRIEF DESCRIPTION OF THE DRAWINGS

FIG. 1(a) is a perspective view of a curved glass plate,

FIG. 1(b) is a section view showing principal portions of the glass plate,

FIG. 2 is a schematic construction view of an apparatus for manufacturing the curved glass plate,

FIG. 3 is a perspective view showing principal portions of the curved glass plate manufacturing apparatus,

FIG. 4 is a section view showing principal portions of the manufacturing apparatus,

FIG. 5 is another section view showing the principal portions of the apparatus.

### DESCRIPTION OF PREFERRED EMBODIMENTS

A preferred embodiment of a cared glass plate relating to the present invention will be now described in details with reference to the accompanying drawings.

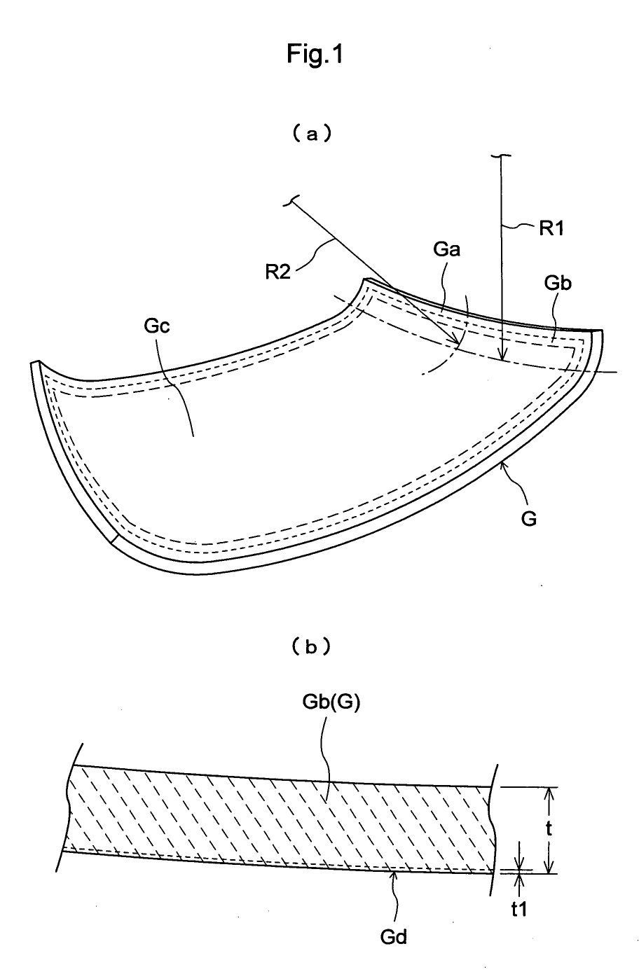

The curved glass plate relating to the present invention is particularly suitable for use as an outdoor side glass plate of a laminated glass employed in an automobile. As shown in FIG. 1, this cured glass plate G has a thickness (t) ranging from 1.5 to 2.5 mm and includes a curved peripheral surface portion where R1×R2 is 1,500,000 mm² or less, R1 being a radius of curvature determined in a direction parallel to an edge of the glass plate, R2 being a radius of curvature determined in a direction normal to said direction.

Further, this curved glass plate shown in FIG. 1 is for use in particular as an outer side glass plate of a laminated glass employed in a front windshield of an automobile. Here, the above R2 is represented by a radius of curvature of the curved portion extending by 50 mm from the right or left edge of the glass plate.

The curved glass plate G includes a residual plane compressive stress zone Ga extending along the peripheral edge and a residual plane tensile stress zone Gb extending along the inner side of the residual plane compressive stress zone Gc. The glass plate G further includes a residual surface compressive stress zone Gc comprising the entire central area of the plate located on the inner side of the residual plane tensile stress zone Gb.

Though the values may vary depending on respective points of measurement even in a single glass plate, the residual plane compressive stress zone Ga has a compressive stress value from 10 MPa to 70 MPa and the residual plane tensile stress zone Gb has a tensile stress value below 8 MPa. Further, the residual surface compressive stress zone Gc has a residual surface compressive stress value ranging from 10 MPa to 30 MPa.

Moreover, the residual plane tensile stress zone Gc located an outer side of the curved surface of the curved glass plate G is covered with a compressive stress layer Gd with a thickness (t1) of 0.15 mm or more in cross section thereof.

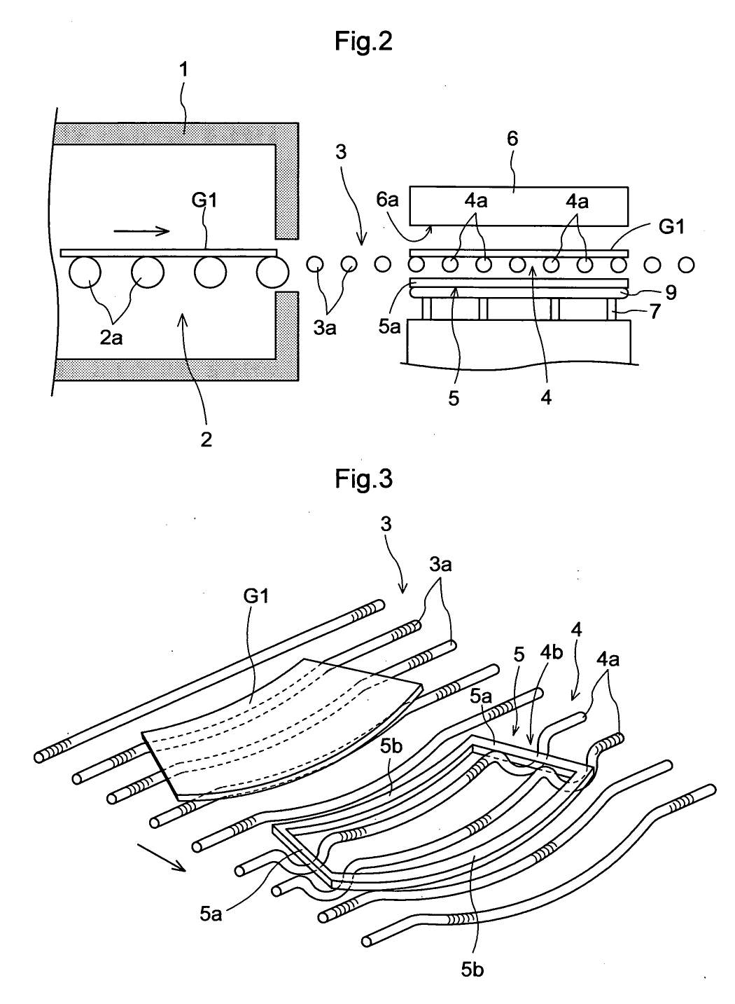

FIGS. 2 and 3 show an apparatus employed for manufacturing the curved glass plate G described above. This apparatus includes a heating furnace 1 for heating a flat glass plate (blanks) G1 and inside the heat furnace 1, there is arranged a roller type inner-furnace conveyer 2 comprising many straight rollers 2a.

On the conveying-wise downstream of the inner-furnace conveyer 2 and outside the heating furnace 1, there is arranged a first conveyer 3 which is constructed also as a roller type conveyer comprising a plurality of curved rollers 3a. Further, on the downstream of the first conveyer 3 and outside the heating furnace 1, there is arranged a second conveyer 4 which is constructed also as a roller type conveyer comprising a plurality of curved rollers 4a.

The first conveyer 3 and the second conveyer 4 are provided for progressively bending the heated glass plate G1 in advance. At a portion of the second conveyer 4, there are disposed a lower mold 5 (known as a ring mold) arranged downwardly of the second conveyer 4 and an upper mold 6 disposed upwardly of the conveyer 4.

The lower mold 5 is adapted for supporting a lower face peripheral edge of the glass plate G1. For this purpose, the lower mold 5 is provided as a rectangular frame-like assembly consisting of a pair of vertical frame members 5a corresponding to the opposed lateral sides of the glass plate and a pair of lateral frame members 5b corresponding to the upper and lower sides of the glass plate. Further, this lower mold 6 is adapted to be movable up/down by means of an unillustrated cylinder or the like via a plurality of struts 7 extending downwardly.

When the lower mold 5 is moved to its lowermost position, the pair of vertical frame members 5a are received within opposed concave portions 4b of the curved rollers 4a and also the pair of lateral frame members 5d are located downwardly of a conveying plane of the second conveyer 4, thereby to avoid interference with the respective curved rollers 4a or the glass plate G1.

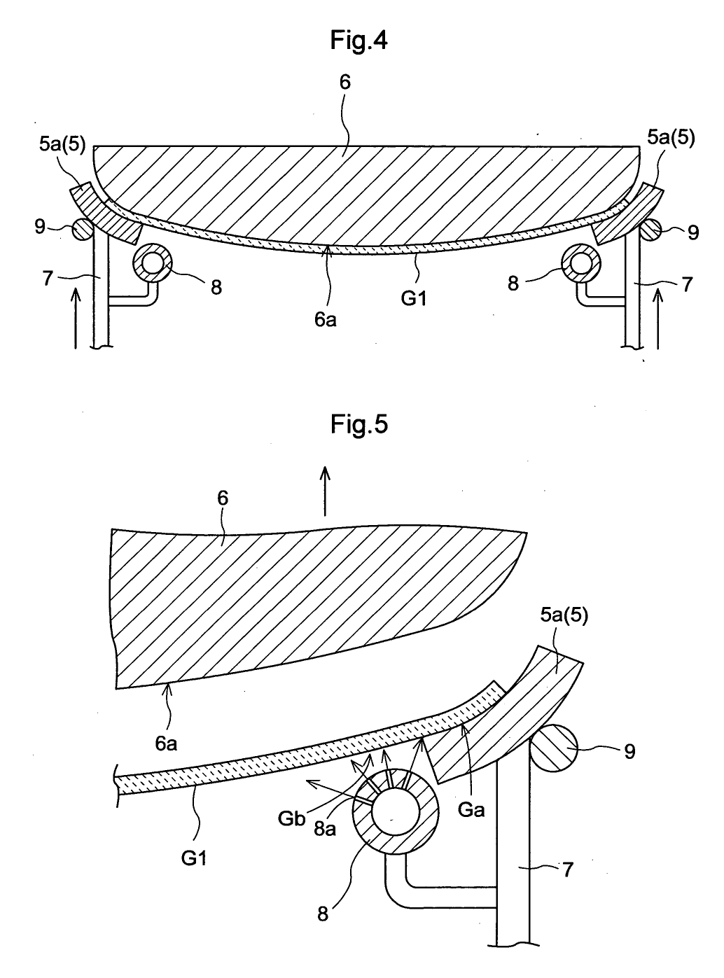

As shown in FIGS. 4 and 5, the lower mold 5 incorporates a cooling air pipe 8 arranged along the inner sides of the vertical frame member 5a and the lateral frame member 5b and a heater 9 aged in contact with bottom faces of the vertical frame member 6a and the lateral frame member 5b. The cooling air pipe 8 and the heater 9 are adapted to be movable up/down together with the lower mold 5. The cooling air pipe 8 defines a number of air discharging holes 8a.

On the other hand, the upper mold 6 includes a curvature-forming curved surface portion 6a which bulges downwardly. In operation, by lifting up/down the lower mold 5 and also the upper mold 6 if necessary, the lower mold 5 can be moved closer to or away from the upper mold 6.

Next, a series of operations of this curved glass plate manufacturing apparatus and a method of manufacturing the plate using the apparatus will be described.

First, in association with rotational drive of the straight rollers 2a thereof, the inner-furnace conveyer 2 conveys the flat glass plate G1 inside the heating furnace 1 in a direction indicated by the arrow. During this conveying operation, the heating furnace 1 heats the glass plate G1 to a predetermined temperature, i.e. a temperature at which the plate can be deformed.

The glass plate G1 existing the furnace is then conveyed by the first conveyer 3 and then by the second conveyer 4. During a series of these conveying operations, the lass plate G1 is progressively bent by the curved rollers 3a, 4a of the respective conveyers 3, 4 which are being rotatably driven.

When the glass plate G1 reaches a predetermined position on the second conveyer 4, the conveying operation of the glass plate G1 by the second conveyer 4 is stopped. Then, the lower mold 5 is lifted up, so that the peripheral edges of the four sides of the rectangular bottom face of the plate G1 are supported on and lifted up by the pair of vertical frame members 5a and the pair of the lateral frame members 5b.

In association with the above-described lifting operation, the top face of the glass plate G1 is pressed against the upper mold 6 with a predetermined pressing force. Then, while the glass plate G1 is clamped between the lower mold 5 and the upper mold 6 and also the plate G1 is forcibly drawn and sucked against the curved surface 6a of the upper mold 6 by means of an unillustrated sucking means incorporated in this upper mold 6, the glass plate G1 is bent by the curved surface 6a. As a result of this operation, the glass plate G1 is now provided with the aforementioned curved peripheral surface portion where R1×R2 is 1,500,000 mm² or less, R1 being a radius of curvature determined in a direction parallel to an edge of the glass plate, R2 being a radius of curvature determined in a direction normal to said direction.

During the above-described molding operation, the lower mold 5 is heated by the heater 9 incorporated therein, so that excessive cooling of the four side peripheral edges of the glass plate G1 by the lower mold 5 is avoided.

Thereafter, the lower mold 5 is lowered to a predetermined position and/or the upper mold 6 is raised to a predetermined position. Then, the curved glass plate G1 as being left mounted on the lower mold 5 is cooled by natural or near-natural cooling (by applying additional cooling air during the natural cooling).

In the course of the above, since the lower mold 5 has a high temperature as described above, as shown in FIG. 5, of the bottom face of the glass plate G1 (corresponding to the “outer side of the curved surface of the curved glass plate”), the portion (corresponding to the “residual plane tensile stress zone”) Gb adjacent the portion (corresponding to the “residual plane compressive stress zone”) Ga placed in contact with the lower mold 5 is affected by radiation from the hot lower mold 5, so that the portion Gb is heated to a temperature higher than the remaining portion of the glass plate G1.

However, with the above-described apparatus, during the cooling operation of the glass plate G1, cooling air is discharged from the cooling air discharging holes 8a of the cooling air pipe 8, so as to forcibly cool the bottom face of the contacting inner portion Gb described above. Therefore, the effect of radiation from the lower mold 5 can be restricted to prevent the surface residual stress of the bottom face of the residual plane tensile stress zone Gb from becoming a tensile stress. As a result, there is obtained the above-described curved glass plate G (final product) wherein the residual plane tensile stress zone Gb on the inner side of the residual plane compressive stress zone has a tensile stress value below 8 MPa and the residual surface compressive stress zone located on the inner side thereof has a residual surface compressive stress value ranging from 10 MPa to 80 MPa and is covered with the compressive stress layer t with a thickness of 0.15 mm or more in cross section thereof.

Thereafter, the carved glass plate manufactured in the manner described above can be affixed with a separately manufactured indoor side glass plate to form a laminated glass (assembly). As the outdoor side glass surface of this curved glass laminated glass is covered in its entire area with the residual compressive stress layer, the spontaneous development of crack due to a surface damage resulting from hitting of a cast stone or the like can be prevented.

### Other Embodiments

In the foregoing embodiment, after the flat glass plate G1 is heated in the heating furnace 1, the pressing operation is effected on the heated glass plate G1 outside the heating furnace 1 by means of the lower mold 5 and the upper mold 6, thereby to obtain the curved glass plate G. Instead, for obtaining the curved glass plate G, the pressing operation may be effected inside the heating furnace 1. Further, for bending the flat glass plate 1, instead of the pressing mold operation described above, it is also possible to utilize the weight of this heated glass plate G per se for bending the heated plate G1, thereby to obtain a desired curved glass plate. Hence, in the present invention, the manufacturing method of the curved glass plate G is not particularly limited.

Further, in the foregoing embodiment, the contacting inner portion Gb is forcibly cooled by means of the cooling air discharged from the air discharging holes 8a of the cooling air pipe 8. Instead, such forcible cooling is possible also by providing a cooling water pipe adjacent the contacting inner portion Gb. Hence, various constructions or devices may be employed for cooling the contact inner portion Gb.

Similarly, as mean for heating the lower mold 5, instead of the heater 9, a high temperature air or fluid discharging pipe may be provided.

1. A curved glass comprising a curved peripheral surface portion where R1×R1 is 1,500,000 mm² or less, R1 being a radius of curvature determined in a direction parallel to an edge of the glass plate, R2 being a radius of curvature determined in a direction normal to said direction;
wherein said curved peripheral surface portion includes a residual plane compressive stress zone and a residual plane tensile stress zone with an inner side and an outer side on the inner side of the residual plane compressive stress zone, the residual plane tensile stress zone having a tensile stress value below about 8 MPa; and
the glass plate further includes a central portion located on the inner side of the residual plane tensile stress zone, said entire central zone comprising a residual surface compressive stress zone having a residual surface compressive stress value ranging from about 10 MPa to about 30 MPa.

2. The curved glass plate according to claim 1, wherein said curved glass plate has a thickness of from about 1.5 to about 2.5 mm, and said residual plane tensile stress zone is provided on the outer side of the curved surface of the curved glass plate, said residual plane tensile stress zone being covered with a compressive stress layer with a thickness of about 0.15 mm or more in cross section thereof.

3. The curved glass plate according to claim 1, wherein said residual plane compressive stress zone has a residual surface compressive stress value ranging from about about 10 MPa to about 70 MPa.
